(19) United States
(12) Patent Application Publication
(10) Pub. No.: US 2007/0226295 A1
(43) Pub. Date: Sep. 27, 2007

(54) Method and apparatuses for retrieving messages

(75) Inventors: Adamu Haruna, Tampere (FI); Arto Leppisaari, Kangasala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/389,676

(22) Filed: Mar. 23, 2006

(51) Int. Cl. G06F 15/16

(52) U.S. Cl. 709/204; 709/206

(57) ABSTRACT

The invention relates to retrieving a conversation or part of the conversation from a database to a terminal. The database contains one or more groups of messages having a first identifier. Each group of messages comprises messages of a conversation. Each message in the group may also have a second identifier. To retrieve the message a group of messages is selected from the database. Then, a message from the selected group of messages is selected and a request is formed. The request is included with the first identifier indicating the selected group of messages. It is also possible that the second identifier indicating the selected message in the selected group of messages is also included in the request. The request is transmitted to a network element controlling the database. The selected message is searched from the database on the basis of the first and the second identifier. If the selected message is found, it is transmitted from the database to the terminal.

### FIELD OF THE INVENTION

The present invention relates to communication services and a method and apparatuses to search and retrieve conversations or messages of conversations stored in a memory.

### BACKGROUND OF THE INVENTION

Instant messaging (IM) service provides message exchanging procedures for client terminals. One standardization instance developing inter alia IM related standards is the Open Mobile Alliance (OMA). There are also other instances developing IM type services, for example the XMPP (Extensible Messaging and Presence Protocol), also known as Jabber.

Instant Messaging (IM) refers to the transfer of messages between users in near real-time. These messages are usually short, but they are not required to be short. Especially when the messages contain images, videos or audio, the messages can be very large, even several megabytes. At present, the IM service typically has at least two different modes: a session based messaging (e.g. a conversational mode) and a pager mode. In the session based messaging a communication session is established for the users to exchange messages while in the pager mode the messages are sent as one-shot messages i.e. without a communication session between the users. The session based messaging can show to the users as an interactive conversation because the message delivery is near real-time. In the pager mode a message is stored in a message data base of a network from which the intended recipient of the message can later retrieve the message. The messages transmitted during the communication session can also be stored into a database of a network for later retrieval e.g. in situations in which the recipient is e.g. temporarily unavailable to receive the IM message.

The OMA is specifying IM service, namely OMA SIP/SIMPLE IM 1.0. The service is based on IETF (Internet Engineering Task Force) specified SIP/SIMPLE protocol, such as SIP (Session Initiation Protocol), MSRP (Message Session Relay Protocol) and XCAP (XML Configuration Access Protocol). SIP is an application layer protocol that can establish, modify and terminate sessions. SIP can also invite participants to already existing sessions. SIP uses certain messages for performing the tasks. A register message is used to register identifying addresses (URL, Uniform Resource Locator) of the users; an invite message provides a method for a session setup; a bye message provides a method for session termination; a notify message transports an event notification; and a reinvite message modifies a setup session. SIMPLE is an abbreviation of Session Initiation Protocol for IM and Presence Leveraging Extension. SIMPLE is a set of extensions to the SIP protocol defining signalling methods to handle the transport of data and presence: message and subscribe. MSRP is a text-based protocol for delivering messages during a session. XCAP is a protocol e.g. for managing presence related data, such as manipulation of resource lists and authorization lists. OMA has selected to use SIP MESSAGE and MSRP procedures for pager mode messaging and MSRP for session based messaging. MSRP is also used for retrieving stored pager mode messages from the network.

Conversations are messaging sessions between two or more users. User can request to store messages of an incoming session or to start recording messages during an active conversation. This kind of feature is known as IM Conversation history. Conversation storing is performed in two different network elements: IM server and IM XML Document Management Server (XDMS). The IM server stores the actual conversation data and the IM XDMS stores the conversation metadata such as a date, a time, and a participant list. Users can manage the IM conversation metadata (the conversation history) in IM XDMS.

If a user wants to retrieve a stored conversation, the user can get the conversation address from the IM XDMS and start retrieving of the stored conversation.

A stored conversation may contain different amount of messages (from 2 to several hundreds) and each message can have text or multimedia content. This means that the size of the stored conversation may vary a lot.

Therefore, it might not be appropriate to download the whole conversation, especially if the size is not known prior to the download.

The Session Initiation Protocol is specified by the SIP WG and is described at RFC 2543 by Handley et al., entitled “SIP: Session Initiation Protocol” Aug. 6, 2000 found at draft-ieff-sip-rfc2543bis-01.ps. It is an application layer control (signalling) protocol for creating, modifying and terminating sessions with one or more participants.

The Session Initiation Protocol (SIP) is an application-layer control protocol that can establish, modify and terminate multimedia sessions or calls. SIP is text-based, using ISO 10646 in UTF-8 encoding throughout. This makes SIP flexible and extensible and since it use for initiating multimedia conferences rather than delivering data, the overhead for using text-based is not significant. The syntax of the messages is similar to HTTP but SIP instead can carry the transaction using either UDP or TCP.

SIP is primarily meant to set up sessions between humans identified by e-mail-like identifiers or telephone numbers, but anything addressable by a host name can participate in a SIP session. The process of session setup involves the discovery of a user wherever located so that a description of the session can be delivered to the user.

The entities involved in a SIP session are the User Agent, the Proxy server, the Redirect server, the Registrar server and the Location server.

The User Agent (UA) can act like a client (UAC) that is a client application that initiates a SIP request. The User Agent can also act like a server (UAS) that is a server application that contacts the user when a SIP request is received and send back a response on behalf of the user. The User Agent is a software component for the end user (the user of the terminal) to perform SIP operations.

The Proxy server is an intermediate entity that behaves like client and server simultaneously. It can interpret and modify the request before forwarding it to other servers.

The Redirect server is an entity that receives the request and maps the address to which the message was initially directed into zero or more new addresses. Then, the client should try again using the new addresses returned from the Redirect server to contact the caller or another SIP server that can handle the message in the case of special requirements.

The Registrar server is a server that accepts the user registration (REGISTER message) and can make this information available through the location server. The Location server is an element used by a Redirect or Proxy server to obtain information about the possible location of the callee. It can include Registrar server or any mobility registration protocol available for this purpose.

To make the initiation of voice calls easier a radiophone-type “push-to-talk” call has been developed for cellular networks. This kind of arrangement is generally called as a PoC network (push-to-talk over cellular network). OMA is also specifying a new release of PoC service, PoC Release 2.0. It contains PoC Box service similar to IM Conversation history feature. Users can store PoC voice conversations into PoC Box located in a network or in a terminal. Stored conversations can be retrieved later. Mechanism presented here for message retrieval can be utlised for Push-to-talk over Cellular (PoC) and other SIP based services.

### SUMMARY OF THE INVENTION

This invention describes novel mechanisms for conversation retrieval. In an example embodiment of the invention more specific data about the conversation content is added to the conversation metadata stored in a server, such as in a IM XDMS. The invention is based on the idea that the stored contents of a conversation are provided with a unique identifier and the protocol messages have a structure for carrying the unique identifiers to the server which can locate and retrieve the requested contents on the basis of the unique identifiers.

According to a first aspect of the invention there is provided a method for retrieving at least one message from a database to a terminal, the database containing one or more groups of messages, the group of messages having a first identifier, and each group of messages comprising messages of a conversation, the method comprising:

selecting a group of messages from the database;

forming a request;

including the first identifier indicating the selected group of messages;

transmitting the request to a network element controlling the database;

searching the selected group of messages from the database on the basis of the first identifier; and

transmitting at least one message of the selected group of messages from the database to the terminal.

According to a second aspect of the invention there is provided a system comprising

an instant messaging server comprising a database for storing one or more groups of messages of a conversation, the group of messages having a first identifier, and each group of messages comprising messages of a conversation;

a document management server comprising a memory for storing at least information relating to the groups of messages stored in the database;

a metadata retriever for retrieving a list of the groups of messages stored in the database;

a first interface for transmitting at least part of the first identifiers of the groups of messages to a terminal;

a second interface for receiving a request including the first identifier indicative of a selected group of messages;

a message retriever for retrieving messages from the selected group of messages from the database; and

a third interface for transmitting at least one message from the selected group of messages.

According to a third aspect of the invention there is provided a terminal comprising

an instant messaging application;

a communication block;

a metadata retriever for retrieving a list of the groups of messages stored in a database the group of messages having a first identifier, and each group of messages comprising messages of a conversation;

a first interface for receiving at least part of the first identifiers of the groups of messages;

a selector for selecting a group of messages;

a second interface for transmitting a request including the first identifier indicative of messages to be retrieved from a selected group of messages; and

a third interface for receiving at least one message of the selected group of messages.

According to a fourth aspect of the invention there is provided a network element comprising

a database for storing one or more groups of messages of a conversation, the group of messages having a first identifier, and each group of messages comprising messages of a conversation;

a first interface to a document management server comprising a memory for storing at least information relating to the groups of messages stored in the database;

a second interface for receiving a request including the first identifier indicative of a selected group of messages;

a message retriever for retrieving messages from the selected group of messages from the database; and

a third interface for transmitting at least one message from the selected group of messages.

According to a fifth aspect of the invention there is provided a computer program product for retrieving a message from a database to a terminal, the database containing one or more groups of messages, the group of messages having a first identifier, and each group of messages comprising messages of a conversation, wherein the computer program product comprises instructions for:

selecting a group of messages from the database;

forming a request;

including the first identifier indicating the selected group of messages;

transmitting the request to a network element controlling the database;

searching the selected group of messages from the database on the basis of the first identifier; and

transmitting at least one message of the selected group of messages from the database to the terminal.

According to a sixth aspect of the invention there is provided a signal for retrieving a message from a database to a terminal, the database containing one or more groups of messages, the group of messages having a first identifier, and each group of messages comprising messages of a conversation, wherein the signal comprises the first identifier indicating the selected group of messages.

According to a seventh aspect of the invention there is provided a carrier having a signal recorded thereon for retrieving a message from a database to a terminal, the database containing one or more groups of messages, the group of messages having a first identifier, and each group of messages comprising messages of a conversation, wherein the signal comprises:

the first identifier indicating the selected group of messages.

According to an eight aspect of the invention there is provided a wireless terminal comprising

an instant messaging application;

a communication block;

a metadata requester for requesting a list of the groups of messages stored in a database the group of messages having a first identifier and each group of messages comprising messages of a conversation;

a first interface for receiving at least part of the first identifiers of the groups of messages;

a selector for selecting a group of messages;

a second interface for transmitting a request including the first identifier indicative of a selected group of messages; and

a third interface for receiving at least one message of the selected group of messages.

Conversation retrieval mechanism as described in this invention can be used for other SIP based services than IM. This mechanism can also at least partly be utilised for services using other transport protocols than MSRP. In the case of PoC service, MSRP or RSTP/RTP protocols could be used for conversation retrieval and at least e.g. the indexing of conversations can be utilised.

Also the invention provides an interface to select a specific media component of a selected group of messages, if that particular group of messages contains several components like text, audio, video, etc.

The invention makes it possible to retrieve only parts of the conversation or one or more specific media components of the conversation instead of retrieving the whole conversation. This can reduce the traffic load of a communication network and also make it easier for the user to find and receive only such parts of the conversation which might have some interest to the user or which he wants to receive. This approach can also reduce the power consumption of the receiving device because the amount of information to be transmitted is less than if whole conversations were received.

### DESCRIPTION OF THE DRAWINGS

In the following the present invention will be described in more detail with reference to the appended drawings, in which

FIG. 1a depicts an instant messaging system as a simplified block diagram,

FIG. 1b depicts some functional elements of the instant messaging system as a simplified diagram,

FIG. 2 depicts a signalling diagram of a message retrieval according to an example embodiment of the present invention,

FIG. 3 depicts an example of a protocol stack in a device compliance with the SIP/SIMPLE protocol,

FIGS. 4a-4c depict examples of SIP messages according to the present invention,

FIG. 5 shows as a block diagram a terminal device according to an example embodiment of the present invention,

FIG. 6 shows as a block diagram an IM server according to an example embodiment of the present invention, and

FIG. 7 shows as a block diagram a Document Managing Server according to an example embodiment of the present invention, and

FIG. 8 is a flow diagram of a method according to an example embodiment of the present invention.

### DETAILED DESCRIPTION OF THE INVENTION

In the following the invention will be described in more details using the SIP/SIMPLE based IM architecture as an example implementation but it is obvious that the invention is also applicable to other architectures such as Jabber, PoC etc.

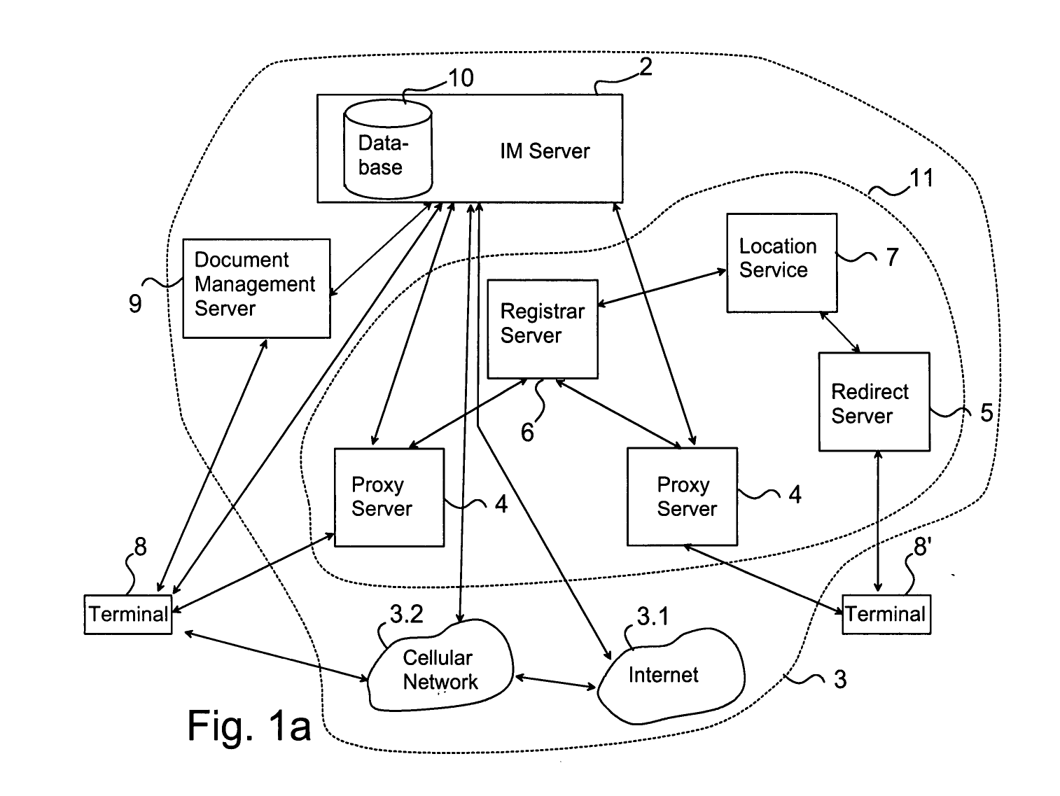

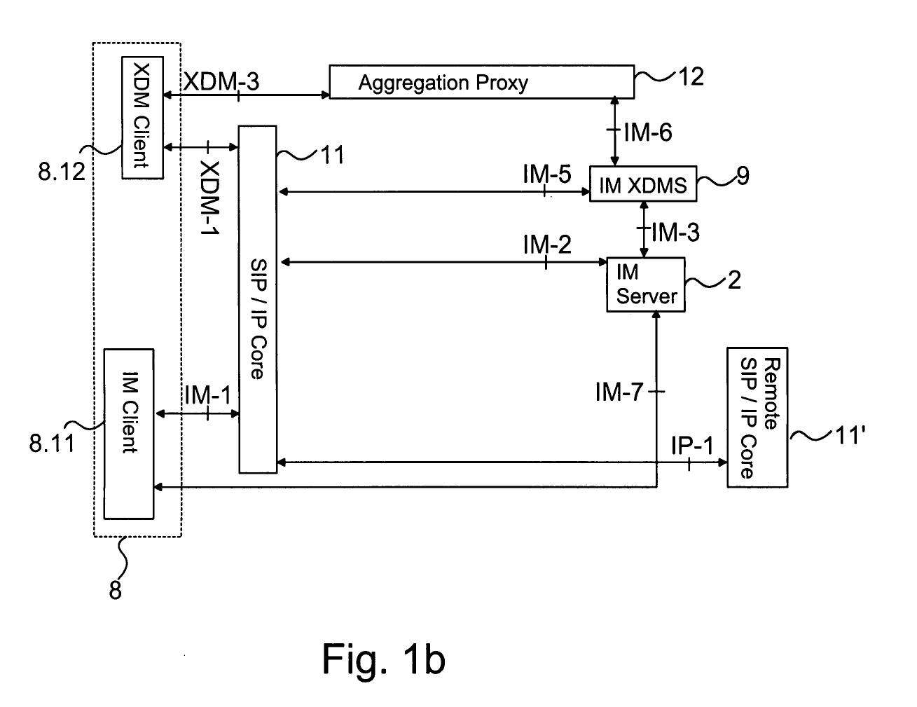

The instant messaging system 1 of FIG. 1a comprises an IM server 2 having a memory 2.2 for storing documents and other contents and information relating to conversations. The IM server 2 is a network element which can communicate with a communications network 3, such as internet 3.1. The system further comprises a document management server 9 for storing e.g. metadata related to the messages stored by the IM server 2. The communications network 3 may also comprise a mobile communications network 3.2 e.g. one or more cellular networks (GSM, UMTS, W-CDMA, . . . ). The system further comprises one or more proxy servers 4, redirect servers 5 and registrar servers 6. In the SIP architecture, the proxy server 4, the redirect server 5 and the registrar server 6 can also be called with a common name: a SIP server and they form the SIP/IP Core network 11.

It should be mentioned here that FIG. 1a only provides an illustrative view of the system and the arrows between different entities of FIG. 1a mainly depict logical connections between different elements. Therefore, data transferred between the elements connected with an arrow may travel a different path than the arrow indicates. For example, the terminal 8, if it is a wireless terminal, normally communicates with the cellular network 3.2 and/or with a WLAN network (Wireless Local Area Network, not shown) to exchange information with e.g. the IM server. On the other hand, the terminal 8 may be provided with a communication element capable of directly communicating with e.g. the IM server 2.

In FIG. 1b the simplified architecture of the IM system is depicted. The client e.g. the terminal 8 comprises some functional elements such as the IM client 8.11 and the XDM client 8.12. The IM client 8.11 communicates with the IM server 2 via the SIP/IP core 11 (e.g. via the SIP proxy servers). The XDM client 8.12 of the terminal 8 can communicate with the document management server 9 through the aggregation proxy 12.

The terminal 8 has a first SIP interface IM-1 for the IM client 8.11 towards the SIP/IP core 11 used for signalling. The terminal 8 has a MSRP interface IM-7 for the IM client 8.11 towards the IM server 2 to be used for transporting data. The terminal 8 also has an XCAP interface XDM-3 for the XDM client 8.12 towards the document management server 9 and a second SIP interface XDM-1 for the XDM client 8.12 towards the SIP/IP core network 11.

The IM server 2 has an XCAP interface IM-3 towards the document management server 9 and also SIP interfaces IM-2, IM-5 towards the document management server 9 via the SIP/IP core 11.

The FIG. 1b also shows a remote SIP/IP core network 11′ with which the SIP/IP core network 11 can communicate through the IP-1 interface.

The proxy server 4 can receive SIP messages from a terminal 8, request location information of a recipient's terminal 8′ from a location service 7, and forward the received SIP messages to the recipient's terminal 8′, if the recipient's terminal 8′ is in the same domain than the proxy server 4, or to another proxy server 4′, if the recipient's terminal 8′ is in another domain than the proxy server 4 which received the SIP message.

Also the redirect server 5 can receive SIP messages from a terminal 8 and request location information of a recipient's terminal 8′ from a location service 7. However, the redirect server 5 does not forward the received SIP messages to the recipient, but the redirect server 5 sends the location information to the terminal 8 which transmitted the SIP message as a response to the SIP message. The terminal 8 can use the received location information to send an instant message to the recipient's terminal 8′ e.g. via one or more other proxy servers.

It is not necessary to transmit the message to the recipient's terminal 8′ but the proxy server 4 can temporarily store the message e.g. into a database 10 of the IM server 2. The proxy server 4 sends only a notification of the incoming message to the recipient's terminal. Then, the user can retrieve the message from the database 10.

The registrar server 6 can receive location messages from the terminals 8, 8′, and ask the location service 7 to store the location information of the terminal 8, 8′. The location service 7 can be implemented e.g. in the registrar server 6, or in another server. The location information is, for example, an ip-address of the terminal 8, 8′.

Terminals 8, 8′ can be registered to the network 3 to make the network 3 aware of the presence and location of the terminals 8, 8′. The registration can be performed by sending a register message from the terminal 8, 8′ to the registrar server 6.

The user can also register more than one terminal for receiving instant messages. Then, if a SIP server receives a message addressed to the user, the SIP server asks the location information from the location service 7, wherein the location service 7 can send location information of all the registered locations of the user's terminals. The SIP server can then send a notification of the incoming message to all the user's terminals and the user can read the message from any of the terminals which received the notification of the incoming message.

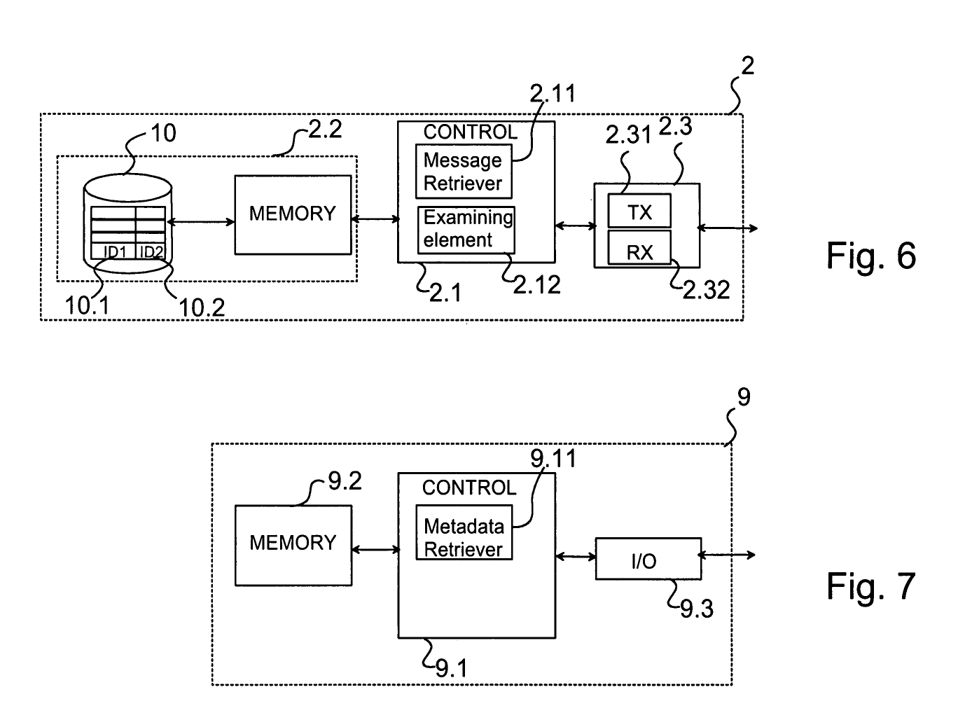

In the following the details of the IM server 2 will be described in more detail with reference to FIG. 6. The IM server 2 comprises a control block 2.1 which controls the operations of the IM server 2. The control block 2.1 can comprise one or more processors wherein the operations of the IM server 2 can mostly be implemented in software i.e. as a program code of the processor(s). There is also the memory 2.2 for storing data. The memory 2.2 can comprise different kinds of memory components, such as read only memory (ROM), random access memory (RAM), non-volatile RAM (NVRAM), a hard disk, etc. In this example embodiment the database for storing messages and message related information is at least partly implemented in the memory 2.2 of the IM server 2. The IM server 2 further comprises a communication block 2.3 for communicating with the communications network 3. The communication block 2.3 comprises a transmitter 2.31 for transmitting data to the communications network 3 and a receiver 2.32 for receiving data from the communications network 3. The IM server 2 further comprises, e.g. in the control block 2.1, a message retriever 2.11 for retrieving messages from the database, and an Examining element 2.12 for examining inter alia indications of the message(s) to be retrieved and for informing the message retriever 2.11 of the messages to be retrieved. It is also possible that the memory 2.2 for storing data does not need to be part of the IM server 2, but it could also be an external element or a server having an interface with the IM server 2.

FIG. 7 depicts some elements of the DMS 9. It comprises a control block 9.1 which controls the operations of the DMS 9. The control block 9.1 can comprise one or more processors wherein the operations of the DMS 9 can mostly be implemented in software i.e. as a program code of the processor(s). There is also the memory 9.2 for storing data, such as conversation history metadata. The memory 9.2 can comprise different kinds of memory components, such as read only memory (ROM), random access memory (RAM), non-volatile RAM (NVRAM), a hard disk, etc. The DMS server 9 further comprises an interface block 9.3 for exchanging information with the IM server 2 and the aggregation proxy 12. The DMS 9 further comprises, e.g. in the control block 9.1, a metadata retriever 9.11 for retrieving metadata relating to messages stored in the database 10.

An example embodiment of the terminal 8, 8′ is depicted in FIG. 5. The terminal 8, 8′ comprises a control block 8.1 for controlling the operation of the terminal 8, 8′. The control block 8.1 can comprise one or more processors wherein the operations of the terminal 8, 8′ can mostly be implemented in software i.e. as a program code of the processor(s). There is also a memory 8.2 for storing data. Also the memory 8.2 of the terminal can comprise different kinds of memory components, such as read only memory (ROM), random access memory (RAM), non-volatile RAM (NVRAM), a hard disk, etc. The user interface 8.3 of the terminal 8, 8′ is intended for inputting information and commands entered by the user and for producing visual and/or audio information for the user. The user interface 8.3 can comprise e.g. a keyboard 8.31 and/or another input device e.g. a touch panel, a loudspeaker 8.32 and/or another electro-acoustic transducer for outputting audio signals, and a display 8.33 for outputting visual information. The user interface 8.3 may also comprise a microphone 8.34 or another acusto-electric transducer for inputting audio signals. The terminal 8, 8′ also comprises communication block 8.4 for communicating with the communications network 3. The communication block 8.4 comprises a transmitter 8.41 for transmitting signals and a receiver 8.42 for receiving signals. The transmitter 8.41 and the receiver 8.42 can use wireless or wired methods for the communication. It is also possible that the communication block 8.4 is not an internal part of the terminal 8, 8′ but it can also be an external device, such as a PCMCIA card, wherein the communication block 8.4 and the terminal 8, 8′ may comprise connection elements (not shown) for transferring information between the communication block 8.4 and the terminal 8, 8′. The control block 8.1 of the terminal or some other block can comprise a metadata requester 8.12 for performing at least some of the operations necessary to retrieve a conversation or part(s) of it as will be described later in the description of the invention.

The operations relating to the above mentioned interfaces IM-1-IM-7, XDM-1, XDM-3,and IP-1 can be implemented in the hardware and software of the functional elements of the system. For example, the communication block 2.3 of the IM server 2 can comprise components to implement the operations of the interfaces IM-2, IM-3 and IM-7, and the control block 2.1 of the IM server 2 can comprise the software necessary in the implementation of the interfaces IM-2, IM-3 and IM-7. Respectively, the interface block 9.3 of the DMS 9 can comprise components to implement the operations of the interfaces IM-3, IM-5 and IM-6, and the control block 9.1 of the DMS 9 can comprise the software necessary in the implementation of the interfaces IM-3, IM-5 and IM-6.

In this application it is assumed that the SIP user agents mentioned previously in the description are implemented as a software in the control block 2.1 of the servers and in the control block 8.1 of the terminals 8, 8′. The IM client 8.11 and XDM client 8.12 are implemented as a software in the control block 2.1 of the control block 8.1 of the terminals 8, 8′. The communication block 8.4 of the terminal 8, 8′ can comprise components to implement the operations of the interfaces IM-1, XDM-1 and XDM-3, and the control block 8.1 of the terminal 8, 8′ can comprise the software necessary in the implementation of the interfaces IM-1, XDM-1 and XDM-3.

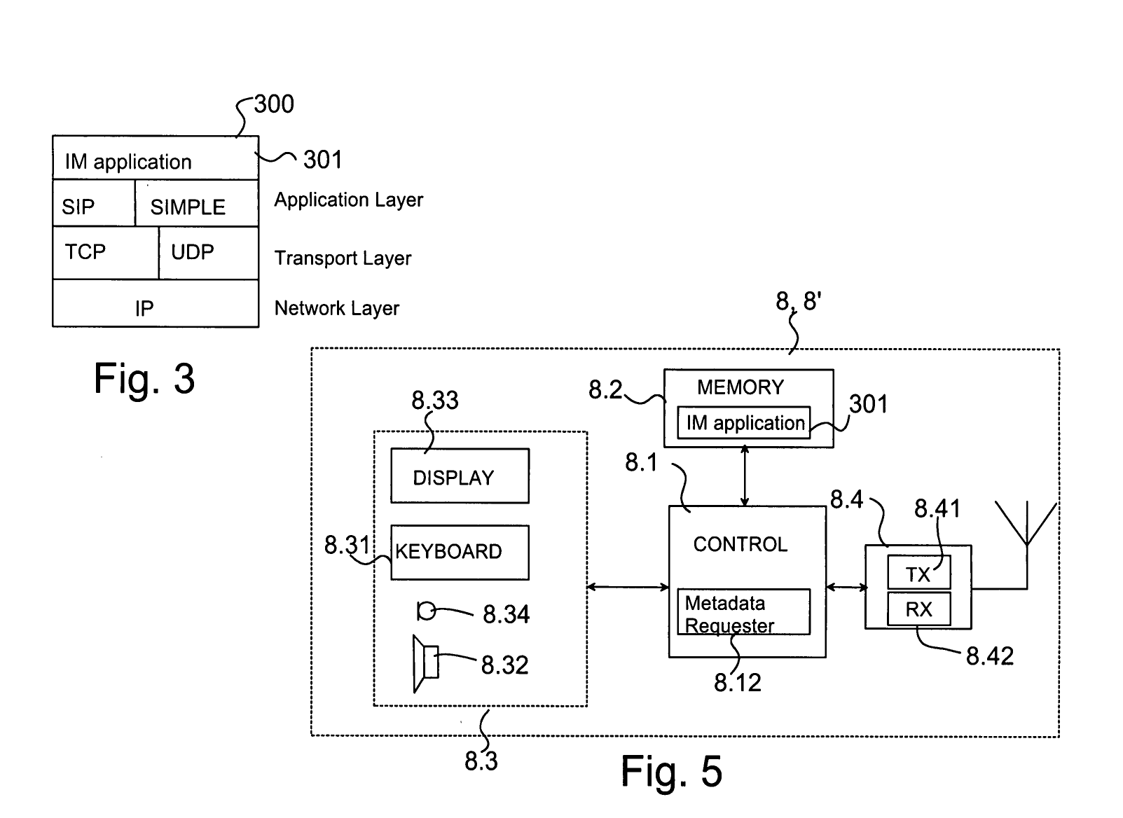

FIG. 3 depicts layers of an example of a protocol stack 300 of the terminal 8, 8′ for instant messaging. The IM application 301 uses the SIP and SIMPLE protocols to transfer and receive instant messages. The SIP and SIMPLE application layer protocols can use both the TCP and UDP protocols at the transport layer. At the network layer the protocol is e.g. the IP (Internet Protocol).

It is obvious to an expert in the field that the system 1, the servers 2, 4, 5, 6 and the terminals 8, 8′ can also comprise other elements than shown in the figures, but it is not necessary to describe them in this context.

SIP Addressing

The entities addressed by SIP are user at hosts and they are identified by a SIP URL, see T. Berners-Lee, R. Fielding and L. Masinter, “Uniform resource Locators (URL),” RFC 1738, IETF, December 1994. The URL takes a form such as user@host where the user part can be a user name or telephone number and the host would be either a domain name or a network address. The SIP URLs are used within the SIP messages to indicate the originator (From), the current destination in the start line (Request URL) and the final recipient (To) of a SIP request. Its interpretation follows the guidelines of RFC 2396 “Uniform resource identifier (UR1),” IETF, August 1998, by T. Berners-Lee et al. and the syntax is described using Augmented Backus-Naur form, using characters reserved within any given URI component.

Message Structure

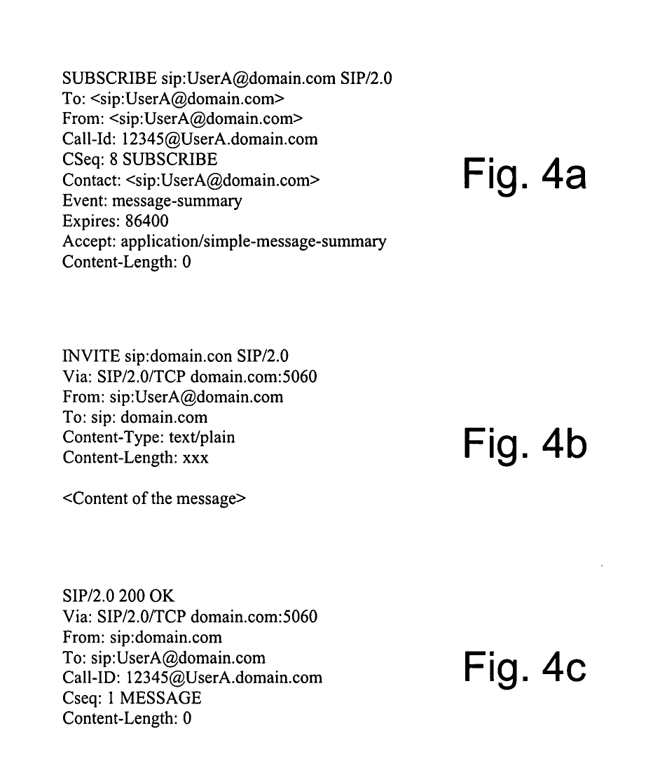

In the system of the present invention information is transmitted between different entities using messages. In the SIP architecture the message consists of a start line, one or more header fields, an empty line (Carriage-return line-feed, CRLF) and an optional body. Three examples are shown in FIGS. 4a-4c.

Basically, the start line indicates if it is a Request (INVITE, ACK, OPTIONS, BYE, CANCEL, REGISTER, etc.) or a Response (100 Informational, 200 Success, 300 Redirection, 400 Client Error, 500 Server Error or 600 Global Failure).

The message header is composed by multiple headers indicating, the Origin (“From:”), Destination (“To:”), Call Identifier (“Call-ID:”), Message Sequence (“Cseq:”), Transaction path (“Via:”), the length (“Content-Length:”) and content (“Content-Type:”) of the body if it carried in the message.

Finally, the message body can contain any kind of data and its interpretation depends of the type of message. Generally the content of the body can contain a session description following a specific format such as the Session Description Protocol (SDP), text or XML scripts. The “Content-Type” header field gives the media type of the message body. If the body has concrete encoding it is indicated in the “Content-Encoding” header field. The body length is given in the “Content-Length” header field.

Message Coding Mechanism

There is a coding mechanism selected/designed for coding/decoding all the messages. All the users must support the coding mechanism.

The users support the basic coding mechanism selected as default for all the transactions. A standard scheme is defined based in a header and a message body. Both are coded using text-based language such as XML. In the header are defined the default fields needed for the protocol transaction including encryption information and in the body are inserted the information according to the specific message. Using an extensible language permits later extensions with new headers or features. This way it has the reliability of the XML format coding and the extensibility of the text-based language.

In the following the operation of the system according to an example embodiment of the present invention will be described. It is assumed that the user of the first terminal 8 is intending to register the first terminal 8 into the network for instant messaging. The user switches the terminal 8 on, if it is not already switched on. The terminal performs the initialization procedure (not shown), which is known as such. When the terminal 8 is ready for communication, the user may then select e.g. using a menu of the terminal 8 the instant messaging option. The control block 8.1 of the terminal recognizes the selection and performs the necessary steps for preparing the terminal 8 for the instant messaging. For example, the control block 8.1 starts an instant messaging application which contains program code for instant messaging. The terminal 8 performs registration to the network 3 and the IM service using a standard SIP/IP core registration service.

In a situation that the user of the first terminal 8 wants to use the instant messaging to have a conversation with the user of the second terminal 8′ the user can invite another user to an instant messaging session. The invitation is performed by forming an invitation message in the first terminal 8 and transmitting the invitation message to the SIP/IP core network 11, for example to the IM server 2. The invitation contains the MSRP media description as an offered media to be used for instant messaging. The SIP/IP core network 11 delivers the invitation message to the second terminal 8′.

When the second terminal 8′ has received the invitation message a notification can be formed by the User Interface 8.3 of the second terminal 8′to inform the user of the first terminal user's intention to begin an instant messaging conversation. The user of the second terminal 8′ can accept or reject the request. The second terminal 8′ send an acknowledgement message (200 OK) to the first terminal 8 via the SIP/IP core network 11 to indicate a successful initiation of an instant messaging session. After that, the conversation can begin.

Both terminals 8, 8′ can send and receive SIP messages during the instant messaging session. The payload part of the message contains the contents of the message. The contents may be a text, a drawing, a multimedia component, a still image, audio information, a game, etc. If one message contains more than one content component, the type of each content component has to be introduced in the header section of the message. It is also possible to transmit each content component in separate messages.

The IM server 2 stores messages of the conversation into the database 10. The storage may be temporary i.e. the message is removed from the database 10 after successful delivery to the recipient(s), or the messages may be stored for a longer period. It is also possible that one of the participants of the conversation may request the recording of the conversation wherein the IM server 2 does not delete messages from the database.

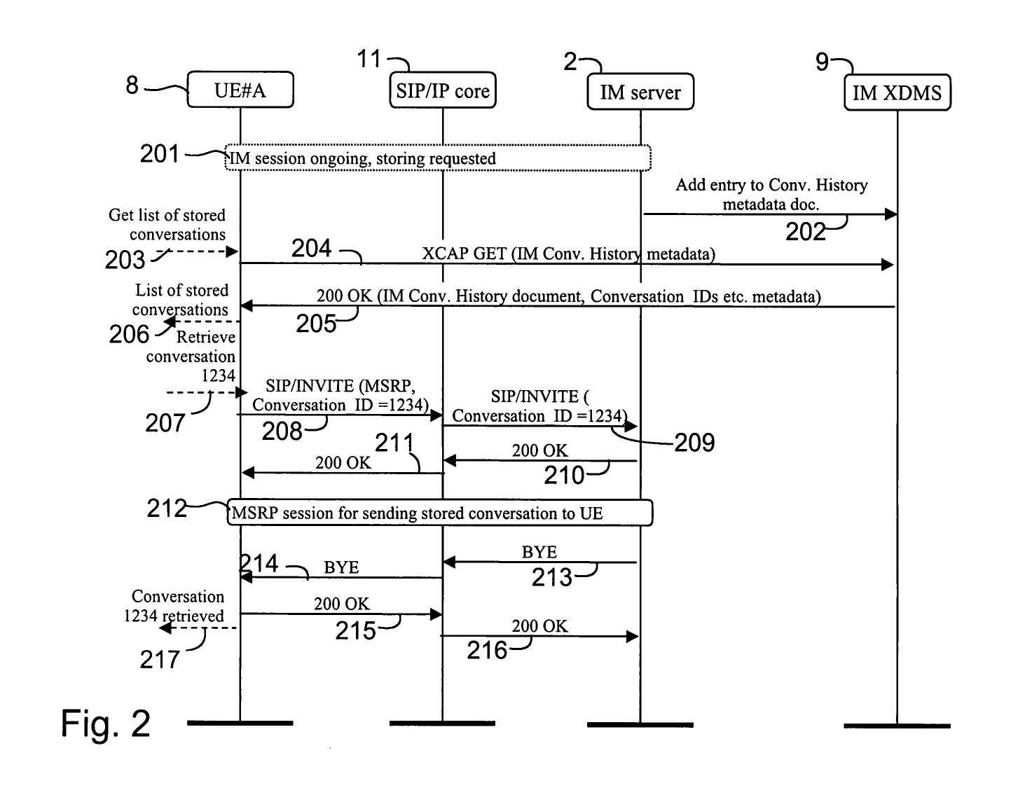

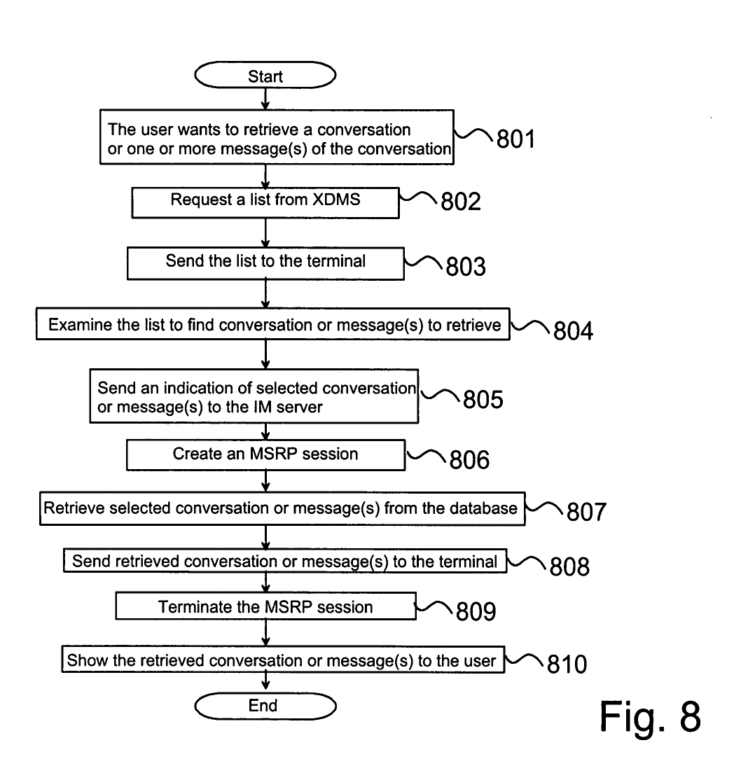

FIG. 2 depicts a signalling diagram of a message retrieval according to an example embodiment of the present invention, and FIG. 8 depicts as a flow diagram a method according to an example embodiment of the present invention.

The block 201 in FIG. 2 depicts the messaging between the first terminal 8 and the IM server 2 during the IM session. It is assumed that one of the participants has requested the recording of the conversation. It is not necessary to show any details on the messaging of the IM session in this context.

The DMS 9 stores information relating to conversations. This additional information can be called as Conversation history metadata. The IM server 2 sends a message (arrow 202 in FIG. 2) to the DMS 9 to add an entry for the stored conversation to the conversation history metadata.

OMA IM working group has defined architecture for conversation storage and retrieval in a way that IM server contains conversation storage functionality and IM XDMS contains the conversation history metadata. The Conversation history metadata would normally contain the following information:
date and time of the conversation;
participant list;
Group URI, if permanent group conversation was stored;
Unique reference to the stored conversation, to be used for retrieval.
the size of the whole conversation, in Kbytes.

The above mentioned unique reference to the stored conversation is called here as a Conversation_ID. There are several ways of forming this Conversation_ID. One possibility is that the IM server 2 generates the unique Server_generated_ID for the conversation. The Conversation_ID can either form complete URL i.e. include also the domain part of the URI or form only the user part of URI. In this latter case, the client needs to add the domain part in order to form complete URL.

Conversation_ID 10.1 (FIG. 6) has, for example, the following form: <Server-generated-ID>@<user account in the conversation server>. <operator>. This can also be the URL of the content in the conversation. The server generated identifier is a string e.g., 84381763998sdasdh09. The domain part of the SIP URI contains the user account identifier in order to separate different users. An example of the URL would be sip:84381763998sdasdh09@bob.operator.com.

In the method according to the present invention the DMS 9 stores additional, information relating to the stored messages of a conversation. This additional information would be added to conversation history metadata. For example, if the conversation relates to PoC, the DMS 9 may store e.g. the RTSP URL so that the terminal 8, 8′ can use realtime streaming protocol (e.g., RTSP) for downloading the content directly from the server. In addition to that, the DMS 9 also stores e.g., the following conversation history metadata information:
the number of messages in the conversation, and
information on each file (image, video, etc.) transmitted in the conversation. The file information could contain the name of the file (<file_name>), the size of the file (<file_size>), and the file identifier (<file_identifier>). The file identifier would be the same as the Conversation Content Identification.

This detailed metadata information is used for selective downloading as described in the examples 5 and 6.

The Conversation Content Identification (Conversation_Content_ID) 10.2 (FIG. 6) is used to address a particular message in the conversation. Conversation_Content_ID has, for example, the following form: <Server-generated-ID>.<Content-ID>@<user account in the conversation server>.<operator>. This is the URL of the content in the conversation (indexing the actual content). The <Server-generated-ID> is the identifier of the conversation the content (<Content-ID>) belongs to.

It should be noted that the term “message” is used here to describe the information element exchanged during the conversation. In the case of IM service, one message normally contains text, images, video/audio clip etc. In the case of PoC service, one message normally contains speech burst, but it can also contain video etc.

The Content-ID contains e.g. a numeric value indicating the position of the Content in that conversation. The content is any complete message, which may be or include a shared file sent in the session. In a situation that MSRP protocol is used for transporting messages, MSRP SEND request contains a message-id identifying the message. If one message is divided to several MSRP SEND requests, the same message-id is used for all of the requests. Therefore, the message-id forms the unique identifier of each message sent inside the MSRP session. The message id can be used for mapping of the numeric value for the content ID. In the case of using some other transport protocol e.g., RTP, Content-ID is formed from the unique identifier of the transport unit forming complete message.

Each stored IM message should have a message-id. The DMS 9 may derive the message-id from the Call-ID, which is the SIP session (also SIP MESSAGE) identifier but also other naming methods shall apply. The message-id forms the user part and the domain part is the home domain name and the calling user's identifier, e.g. message-id@bob.operator.com. It is also possible that the DMS 9 generates the message-id and do not form it from the Call-ID.

There is also an alternative that the Conversation-ID is constructed from the Call-ID of the SIP session. In that case, the Call-ID forms the user part of the Conversation-ID. The domain part with the user account identifier is also needed to separate sessions for each user. When the SIP URI is formed from the Conversation-ID, the @-symbol (%40) in the Conversation-ID may need to be removed or replaced with another symbol (e.g. the string %40).

An example of the Conversation-ID and the Conversation-Content-ID in this case is:

a) Conversation_ID
<Call-ID>@<user account in the conversation server>.<operator>

b) Conversation_Content_ID
<Call-ID>.<Content-ID>@<user account in the conversation server>. <operator>

It is also possible to express the Conversation_Content_ID as follows:
<Call-ID>@<user account in the conversation server>.<operator>;

Content-ID=“content_ID”

The Conversation_ID or Conversation_Content_ID can also take the form of a filename. For example the document http://www.ieff.org/internet-drafts/draft-garcia-sipping-file-transfer-mech-00.txt defines the SDP attribute extensions and usage conventions needed for meeting the requirements on file transfer services within SIP sessions using MSRP as the transfer protocol within a session. The filename identifying the conversation or messages in conversation is either proposed by the user or generated by the server. Client can utilise referenced file transfer mechanism to retrieve the stored conversation or part of the conversation. This is performed by the client sending SIP session establishment request to the IM server 2, the request containing of MSRP media parameters and the filename. The filename could be included into the SDP part of the SIP request as described in the above referred draft or as an URI parameter. An example of including the filename into the SDP part of the SIP request is shown in the following:
m=message 7654 TCP/MSRP *
a=sendonly
a=accept-types:
a=path:msrp://alicepc.example.com:7654/jshA7we;tcp
a=filename:Conversation-15102006-0001.txt
a=filetype:plain/text
a=filesize:91096
a=hash:SHA 72245fe8653ddaf371362f86d471913ee4a2ce2e

It is also possible to establish an MSRP session for stored content retrieval purposes and request the retrieval of messages by including the Conversation_ID or Conversation_Content_ID into the MSRP SEND request.

When the terminal 8, 8′ wants to fetch a stored conversation or part of it, the terminal 8, 8′ uses the Conversation-ID for the particular conversation or the Conversation content ID for the particular content of the conversation

In order to retrieve a stored conversation or a part of the conversation (e.g. a stored pager mode message, a stored message of the session based messaging or PoC talk burst), the terminal 8, 8′ needs to get a list of stored conversations and the detailed description of each conversation. Terminal can either use XCAP to retrieve (204,205) the whole Conversation history metadata document from DMS 9 or to subscribe to the changes of Conversation history metadata document. For the latter one, the terminal 8, 8′ sends a SIP SUBSCRIBE request to the DMS 9 in order to subscribe to the changes of the Conversation history metadata document. The terminal 8, 8′ receives a notification (NOTIFY) whenever a document is changed. This procedure is described in OMA XDMS Core specification “XML Document Management (XDM) Specification”, Version 1.0, Open Mobile Alliance™, OMA-TS-XDM_Core-V1_{—}0, URL:http://www.openmobilealliance.org/ and in IETF draft “A Framework for Session Initiation Protocol User Agent Profile Delivery”, D. Petrie, July, 2005 (URL: http://www.ieff.org/internet-drafts/draft-ieff-sipping-config-framework-07.txt). It is also possible that the terminal 8, 8′ subscribes to the Message Waiting Indication event package for getting a notification when new conversations are stored (RFC 3842 “A Message Summary and Message Waiting Indication Event Package for the Session Initiation Protocol (SIP)”).

### EXAMPLE 1

In the following there is a more detailed description of the situation of the signaling diagram of FIG. 2 in which the terminal 8, 8′ uses XCAP to retrieve the Conversation history metadata document and then retrieve the selected conversation.

To retrieve the list of stored conversations, the terminal 8, 8′ sends a message (204) to the DMS 9. The message contains indication on the name of the method i.e. Conversation history metadata retrieval. The DMS 9 responds (205) to the request by sending a response with the document containing the list of conversations. The list contains a unique identifier of each conversation (i.e. the Conversation_ID) and other detailed information about the conversation needed for selective or partial retrieval as described earlier in this application and in later examples.

The terminal 8, 8′ indicates (206) the list of the stored conversations by the user interface 8.3 of the terminal, e.g. displays the list on the display 8.33. The user can examine the list and select (207, 804) the conversation or message(s) of the conversation. The control block 8.1 of the terminal 8, 8′ forms a session establishment request (SIP/INVITE) (208) containing indication on the used transport protocol (e.g., MSRP, RTP), the conversation and the message(s). The INVITE request can indicate that the MSRP session is unidirectional i.e. the parameter a=recv-only. The body of the INVITE request contains the SIP URI list and the Conversation-ID is included as the only element in the list. In the case of only one URI, the SIP URI list is not necessarily needed, but the Request-URI could be set to the Conversation_ID i.e. SIP URI of the conversation. In the non-limiting example of FIG. 2 the conversation id is 1234.

The session establishment request is transmitted from the terminal 8, 8′ to the SIP/IP core network 11. The SIP proxy server receives the message and forwards 209 it to the IM server 2. If the MSRP session can be established, the IM server 2 sends an acknowledgement message 210 to the SIP proxy server. The SIP proxy server sends an acknowledgement message 211 to the terminal 8, 8′. The MSRP session 212 is established and the IM server 2 searches and retrieves (807) the conversation from the database 10 and sends (212, 808) the conversation to the terminal 8, if no errors occur during the message retrieval from the database 10. When the conversation is transmitted to the terminal 8, the MSRP session can be terminated (809) by transmitting a bye message 213 from the IM server 2 to the SIP proxy server of the SIP/IP core network 11 (or the terminal 8, 8′ can initiate a bye request). The SIP proxy server also transmits a bye message 214 to the terminal 8, 8′. The terminal 8, 8′ acknowledges the bye message by transmitting an acknowledgement message (200 OK) 215 from the terminal 8, 8′ to the SIP proxy server of the SIP/IP core network 11. The SIP proxy server also transmits an acknowledgement message (200 OK) 216 to the IM server 2.

The retrieved conversation is stored in the terminal 8, 8′ and shown to the user (810) by the UI 8.3 of the terminal 8, 8′.

If, for some reason, the MSRP session can not be established, the IM server 2 sends a negative acknowledgement message (not shown) to the SIP proxy server, which forwards the negative acknowledgement message to the terminal 8, 8′.

One example of the SIP URI for an MSRP session establishment request is that the message-id forms the user part and the domain part is the user's mailbox account domain name message-id%40bob.operator.com@client.mailserver.operator.com (the string %40 is another representation of the @-symbol).

### EXAMPLE 2

For example, the user of the first terminal 8 finds out that conversation with Conversation-ID 84381763998sdasdh09@bob.operator.com is interesting but it is very long, 200 messages. The user wants to retrieve the first 20 messages to find out the discussion topic. The terminal 8 (the SIP User Agent) forms identifiers (SIP URIs) for messages 1 to 20 of the conversation. The Conversation_Content_IDs are as following:

84381763998sdasdh09.0001@bob.operator.com

84381763998sdasdh09.0002@bob.operator.com

84381763998sdasdh09.0020@bob.operator.com

Another possible way to express the list of conversation content IDs is as follows:

84381763998sdasdh09@bob.operator.com; Content-ID=“0001”

84381763998sdasdh09@bob.operator.com; Content-ID=“0002”

84381763998sdasdh09@bob.operator.com; Content-ID=“0020”

It is obvious that the above described examples are just illustrative, not limiting examples on how to express identifiers of the messages in the request.

The terminal 8 sends a SIP INVITE request (208) to establish (806) a MSRP session for partial conversation retrieval. The payload (body) of the INVITE request contains the list of the identifiers of the messages i.e. Conversation_Content_Ids for the messages 1 to 20 in the form of SIP URI-list. The SIP/MSRP session is established for message retrieval and terminated after retrieval as described in Example 1.

The form of the indication of the messages of the conversation may depend on the number of messages selected and their indices (i.e. the order numbers of the messages). For example, if the conversation contains several hundreds of messages and the user has selected 20 first messages to retrieve, the indication may contain the content id of each of the selected message. Another alternative is that the indication contains the content id of the first and the last selected message.

It should be noted that the SIP-URI list solution as proposed in this application can also be used for deferred message retrieval.

### EXAMPLE 3

In a situation that the user wants to retrieve a lot of messages (e.g., messages 1-100 of the conversation), the SIP INVITE request with SIP-URI list would be unnecessarily large. An alternative way of indicating the message range would be beneficial. The message range could be indicated in the headers of the SIP INVITE request, e.g. as an URI parameter. For example,

sip:84381763998sdasdh09@bob.operator.com;Conversation_Content_ID_st art=10;Conversation_Content_ID_end=100.

### EXAMPLE 4

If filtering of retrieved messages is needed, SUBSCRIBE/NOTIFY mechanisms could be used to subscribing the conversation. The SUBSCRIBE request could contain detailed filtering criteria for messages that the user wants to retrieve. The server would respond with a NOTIFY containing the requested messages. It requires defining of a new event package for this purpose.

### EXAMPLE 5

The terminal 8 retrieves the conversation history with XCAP from the DMS 9 as above. The conversation history metadata contains information such as the number of messages in each stored conversation, the Conversation-IDs, the sizes of the conversations e.g in kBytes, and details on images, videos etc. shared in the conversation session. The user finds out that the size of the conversation having the Conversation-ID 84381763998sdasdh09@bob.operator.com is very large (e.g. 3 Mbytes) and there was 50 messages sent during the conversation. The user also finds out that there was two videoclips shared during the conversation. The user wants to retrieve the messages but do not want to retrieve the shared videoclips since he/she is using a terminal not able to handle video or a terminal having a relatively slow communication speed for video retrieval, such as a GPRS terminal. The terminal 8 sends the SIP INVITE request to establish the MSRP session for the conversation retrieval. The body of the INVITE request contains the SIP URI-list and the Conversation-ID is included as the only element in the list. In the SDP, the terminal indicate that only the text/plain content type is supported (or requested to be retrieved).

The SDP body of the INVITE request would then contain the following information:

m=message 8888 msrp/tcp *

a=accept-types:text/plain

a=recvonly

In a situation that the message contains several content types the following format is used:

m=message 8888 msrtp/tcp *

a=accept-types: multipart/mixed

a=accept-wrapped-types: text/plain /// To retrieve text only

a=recvonly

An MSRP session is established and the IM server 2 sends all the messages of the conversation to the terminal 8. If a message of the conversation to be retrieved have some multimedia content, the IM server 2 does not send that message to the terminal 8.

### EXAMPLE 6

The terminal 8 retrieves the conversation history with XCAP from the DMS 9 as above. The conversation history metadata contains information the number of messages in each stored conversation, the Conversation-IDs, the sizes of the conversations e.g in kBytes, and details on images, videos etc. shared in the conversation session. The user finds out that the size of the conversation with a particular Conversation-ID is very large (e.g. 3 Mbytes) and there was 50 messages sent during the conversation. The user also finds out that there was one interesting videoclip named “my_new_house.mpg” shared during the conversation. The user wants to retrieve only the shared videoclip. The conversation metadata contains information that the Content_ID for this particular videoclip is 0034. The terminal 8 forms a SIP URI from the Conversation-ID as follows: 84381763998sdasdh09.0034@bob.operator.com. The terminal 8 sends a SIP INVITE request to establish an MSRP session for the conversation retrieval. The body of the INVITE request contains the SIP URI-list and the Conversation-Content_ID is included as the only element in the list. In the SDP, the terminal 8 can also indicate that only the video/mpg content type is supported. However, this is not required.

The body of the INVITE request would then contain the following information:

m=message 8888 msrp/tcp *a=accept-types: multipart/mixed

a=accept-types: multipart/mixed

a=accept-wrapped-types: video/mpg

a=recvonly

An MSRP session is established and the IM server 2 sends the message containing the videoclip to the terminal 8. If the message has some other multimedia contents the IM server 2 does not send those messages to the terminal 8.

### EXAMPLE 7

The terminal 8, 8′ retrieves the conversation history with XCAP from the DMS 2 as above. The conversation history metadata contains information on the number of stored conversations, the Conversation-IDs etc. Since a conversation contains realtime media components such as PoC voice, audioclip, videoclip, Conversation-IDs are in the form of RTSP URL. The terminal 8, 8′ uses the RTSP protocol to establish a session to RTSP URL for streaming of stored conversation(s) from the server to the terminal. This mechanism is particularly suitable for large media files since the user can play the content in the terminal while the downloading is in progress. It is also possible to use any other protocol (e.g. HTTP) for the conversation retrieval. It is only required that the Conversation history metadata indicates the used retrieval protocol in the URL prefix (e.g., sip:, rtsp:) or by some other means.

In the description above the main principles of the present invention were disclosed. It is obvious that details may vary in different embodiments. For example, the SIP servers 2, 4, 5, 6 and the location service 7 may be implemented as separate network elements or some of them may also be implemented in one network element. For example, the document management server 2, the registrar server 6 and the location service 7 may be implemented as one network element.

What is claimed is:

1. A method for retrieving at least one message from a database to a terminal, the database containing one or more groups of messages, the group of messages having a first identifier, and each group of messages comprising messages of a conversation, the method comprising:
selecting a group of messages from the database;
forming a request;
including the first identifier indicating the selected group of messages;
transmitting the request to a network element controlling the database;
searching the selected group of messages from the database on the basis of the first identifier; and
transmitting at least one message of the selected group of messages from the database to the terminal.

2. A method according to claim 1, wherein each message in the group has a second identifier, and the method further comprises:
selecting at least one message from the selected group of messages;
including the second identifier of the selected at least one message in the request indicating the selected message in the selected group of messages;
searching the selected message from the database on the basis of the second identifier;
wherein said transmitting comprises transmitting the at least one selected message from the selected group of messages from the database to the terminal.

3. A method according to claim 1, wherein the messages comprise instant messages of the conversation.

4. A method according to claim 1, wherein the messages comprise files shared during the conversation.

5. A method according to claim 1, wherein the conversation is a voice conversation, wherein the messages comprise talk bursts of the voice conversation.

6. A method according to claim 2, wherein the first identifier is the identifier of the conversation and the second identifier contains the indication of the message of the conversation.

7. A method according to claim 2, wherein the request is a SIP INVITE request to establish a MSRP session.

8. A method according to claim 7, wherein at least one of the first and the second identifier is delivered using SIP URI-list service.

9. A method according to claim 7, wherein at least one of the first and the second identifier is delivered as SIP URI parameters.

10. A method according to claim 7, wherein at least one of the first and the second identifier is delivered in a SIP header.

11. A method according to claim 7, wherein at least one of the first and the second identifier is delivered in a SDP body of the request.

12. A method according to claim 1, wherein the request is a SIP INVITE request to establish a RTP session.

13. A method according to claim 1, wherein the request is a RTSP SETUP request to establish a RTP session.

14. A method according to claim 1 further comprising including in the request an indication on one or more mediatypes to retrieve, wherein said transmitting comprises transmitting only messages with indicated mediatypes.

15. A method according to claim 2 wherein said second identifier comprises an indication of a range of messages of the selected group of messages.

16. A system comprising
a messaging server comprising a database for storing one or more groups of messages, the group of messages having a first identifier and each group of messages comprising messages of a conversation;
a document management server comprising a memory for storing at least information relating to the groups of messages stored in the database;
a metadata retriever for retrieving a list of the groups of messages stored in the database;
a first interface for transmitting at least part of the first identifiers of the groups of messages to a terminal;
a second interface for receiving a request including the first identifier indicative of a selected group of messages;
a message retriever for retrieving messages from the selected group of messages from the database; and
a third interface for transmitting at least one message from the selected group of messages.

17. A system according to claim 16, wherein each message in the group has a second identifier, wherein the request further comprises at least one second identifier in the request indicating the at least one selected message in the selected group of messages; said metadata retriever being further configured to search the at least one selected message from the database on the basis of the at least one second identifier.

18. A system according to claim 16, wherein the messages are instant messages of the conversation.

19. A system according to claim 16, wherein the database comprises files shared during the conversation.

20. A system according to any of the claim 16, wherein the conversation is a voice conversation, wherein the database comprises talk bursts of the voice conversation.

21. A system according to claim 17, wherein the first identifier is the identifier of the conversation and the second identifier contains the indication of the message of the conversation.

22. A system according to claim 16, wherein the request is a SIP INVITE request to establish a MSRP session.

23. A system according to claim 16, wherein the request is a SIP INVITE request to establish a RTP session.

24. A system according to claim 16, wherein the request is a RTSP SETUP request to establish a RTP session.

25. A system according to claim 17 wherein said second identifier comprises an indication of a range of messages of the selected group of messages.

26. A terminal comprising
a messaging application;
a communication block;
a metadata requester for requesting a list of the groups of messages stored in a database the group of messages having a first identifier, and each group of messages comprising messages of a conversation;
a first interface for receiving at least part of the first identifiers of the groups of messages;
a selector for selecting a group of messages;
a second interface for transmitting a request including the first identifier indicative of a selected group of messages; and
a third interface for receiving at least one message of the selected group of messages.

27. A terminal according to claim 26, wherein each message in the group has a second identifier, wherein the selector being further configured to select at least one message from a group of messages; and the metadata requester being further configured to include the selected at least one second identifier in the request indicating the at least one selected message in the selected group of messages.

28. A terminal according to claim 26, wherein the first interface is an XCAP protocol interface; the second interface is a SIP protocol interface; and the third interface is a MSRP protocol interface.

29. A terminal according to claim 28, wherein the request comprises a SIP INVITE request to establish a MSRP session.

30. A terminal according to claim 27, wherein the first identifier is the identifier of the conversation and the second identifier contains the indication of the message of the conversation.

31. A terminal according to claim 27 wherein said second identifier comprises an indication of a range of messages of the selected group of messages.

32. A network element comprising
a database for storing one or more groups of messages of a conversation, the group of messages having a first identifier, and each group of messages comprising messages of a conversation;
a first interface to a document management server comprising a memory for storing at least information relating to the groups of messages stored in the database;
a second interface for receiving a request including the first identifier indicative of a selected group of messages;
a message retriever for retrieving messages from the selected group of messages from the database; and
a third interface for transmitting at least one message from the selected group of messages.

33. A system according to claim 32, wherein each message in the group has a second identifier, wherein the request further comprises at least one second identifier in the request indicating the at least one selected message in the selected group of messages; said message retriever being further configured to retrieve the at least one selected message from the database on the basis of the at least one second identifier.

34. A network element according to claim 32, wherein it is a IM server.

35. A network element according to claim 32, wherein it is a PoC server.

36. A computer program product comprising instructions for retrieving a message from a database to a terminal, the database containing one or more groups of messages, the group of messages having a first identifier, and each group of messages comprising messages of a conversation, wherein the computer program product comprises instructions for:
selecting a group of messages from the database;
forming a request;
including the first identifier indicating the selected group of messages;
transmitting the request to a network element controlling the database;
searching the selected group of messages from the database on the basis of the first identifier; and
transmitting at least one message of the selected group of messages from the database to the terminal.

37. A method according to claim 36, wherein each message in the group has a second identifier, and the computer program product further comprises instructions for:
selecting at least one message from the selected group of messages;
including the second identifier of the selected at least one message in the request indicating the selected message in the selected group of messages;
searching the selected message from the database on the basis of the second identifier;
wherein said transmitting comprises instructions for transmitting the at least one selected message from the selected group of messages from the database to the terminal.

38. A signal for retrieving a message from a database to a terminal, the database containing one or more groups of messages, the group of messages having a first identifier, and each group of messages comprising messages of a conversation, wherein the signal comprises the first identifier indicating the selected group of messages.

39. A signal according to claim 38, wherein each message in the group has a second identifier, and the signal further comprises the second identifier indicating the selected message in the selected group of messages.

40. A signal according to claim 39, wherein it is a SIP INVITE request to establish a MSRP session.

41. A signal according to claim 40 comprising at least one of the first and the second identifier as a SIP URI parameter.

42. A signal according to claim 40 comprising a SIP header, wherein the SIP header comprises at least one of the first and the second identifier.

43. A signal according to claim 40 comprising a SDP body, wherein the SDP body comprises at least one of the first and the second identifier.

44. A signal according to claim 39 wherein said second identifier comprises an indication of a range of messages of the selected group of messages.

45. A carrier having a signal recorded thereon for retrieving a message from a database to a terminal, the database containing one or more groups of messages, the group of messages having a first identifier, and each group of messages comprising messages of a conversation, wherein the signal comprises the first identifier indicating the selected group of messages.

46. A signal according to claim 45, wherein each message in the group has a second identifier, and the signal further comprises the second identifier indicating the selected message in the selected group of messages.

47. A wireless terminal comprising
a messaging application;
a communication block;
a metadata requester for requesting a list of the groups of messages stored in a database the group of messages having a first identifier and each group of messages comprising messages of a conversation;
a first interface for receiving at least part of the first identifiers of the groups of messages;
a selector for selecting a group of messages;
a second interface for transmitting a request including the first identifier indicative of a selected group of messages; and
a third interface for receiving at least one message of the selected group of messages.

48. A wireless terminal according to claim 47, wherein each message in the group has a second identifier, wherein the selector being further configured to select at least one message from a group of messages; and the metadata requester being further configured to include the selected at least one second identifier in the request indicating the at least one selected message in the selected group of messages.
